(19) United States
(12) Patent Application Publication
(10) Pub. No.: US 2026/0135132 A1
(43) Pub. Date: May 14, 2026

(54) LAMINATING APPARATUS FOR LAMINATING MULTILAYER CONTINUOUS WEBS FOR PRODUCING ENERGY CELLS

(71) Applicant: KÖRBER TECHNOLOGIES GMBH, HAMBURG (DE)

(72) Inventors: Michael KLEINE WÄCHTER, Lankau (DE); Manfred FOLGER, Hamburg (DE); Dennis SPRINGBORN, Hamburg (DE)

(21) Appl. No.: 19/119,599

(22) PCT Filed: Oct. 17, 2023
(86) PCT No.: PCT/EP2023/078816

§ 371 Date: Apr. 9, 2025

(30) Foreign Application Priority Data
Oct. 25, 2022 (DE) 10 2022 128 217.1

(51) Int. Cl. H01M 10/04; H01M 10/0585

(52) U.S. Cl. CPC H01M 10/0404; H01M 10/0413; H01M 10/0468; H01M 10/0585

(57) ABSTRACT

The invention relates to a laminating apparatus for a multilayer continuous web made up of at least one separator web and at least one electrode for producing energy cells and that has a pressing device which laminates the multilayer continuous web by exerting a compressive force. The pressing device has a pressing surface with at least one outwardly projecting elevation, which is arranged such that when the compressive force is exerted, it comes into contact with a portion of the continuous web which adjoins an edge side of the electrode.

### The present invention relates to a laminating apparatus for laminating multilayer continuous webs for producing energy cells with the features of the preamble of claim 1.

Energy cells or energy storage devices within the meaning of the invention are used, for example, in motor vehicles, other land vehicles, ships, aircraft or also in stationary systems such as photovoltaic systems, in the form of battery cells or fuel cells in which very large amounts of energy have to be stored over longer periods of time.

For this purpose, such energy cells can have a structure consisting of a plurality of segments stacked to form a stack. These segments are each formed from alternating anode sheets and cathode sheets, which are separated from one another by separator sheets that are also produced as segments. The segments are pre-cut in the production process and then placed on top of each other in the predetermined sequence to form the stacks and joined together by lamination. The anode sheets and cathode sheets are first cut from a continuous web and then placed individually at intervals on a continuous web of separator material. This subsequently formed “two-ply” continuous web made of the separator material with the anode sheets or cathode sheets placed on top is then cut into segments again in a second step by means of a cutting apparatus, wherein the segments in this case are formed in a double layer by a separator sheet with an anode sheet or cathode sheet arranged on top. If this is technically feasible or necessary from a manufacturing perspective, the continuous webs of separator material with the anode sheets and cathode sheets placed on top of each other can also be placed on top of each other before cutting, so that a continuous web is formed with a first continuous layer of separator material with anode sheets or cathode sheets placed thereon and a second continuous layer of separator material in turn with anode sheets or cathode sheets placed thereon. This “four-ply” continuous web is then cut into segments by means of a cutting apparatus, which segments are in this case formed in four layers with a first separator sheet, an anode sheet, a second separator sheet and a cathode sheet lying thereon. The advantage of this solution is that one cut can be saved. Furthermore, the cut electrodes can also be placed on a continuous separator web and stacked on top of each other by another continuous separator web to form a three-ply continuous web, from which three-ply segments with a separator sheet, an electrode sheet and another separator sheet are then cut. “Segments” within the meaning of this invention are therefore single-ply segments of a separator material, anode material or cathode material, or also double-ply, three-ply or four-ply segments of the structure described above.

Furthermore, the “double-ply” or “four-ply” continuous webs described above can also be supplemented by placing another separator web on the electrodes to form a “three-ply” or “five-ply” continuous web, which then has a separator web on each side.

Alternatively, the electrodes can also be provided as continuous webs, i.e., uncut in the “double-ply,” “three-ply,” “four-ply” or “five-ply” continuous webs, which are then cut into considerably longer lengths and then wound up, for example. Alternatively, the continuous webs can be wound first and then cut after winding is complete. In this case, the electrodes in the continuous webs are not present as spaced segments, but instead in a single segment that extends without interruption in the intermediate space between the separator webs.

Furthermore, an electrode in the form of a copper web or copper foil or a comparable carrier material with an intermittent coating can also be provided in the continuous web, in which the coatings each form sectional, spaced-apart elevations in the electrode.

To laminate the “double-ply”, “three-ply”, “four-ply” or “five-ply” continuous webs, they are passed between two pressing devices which exert a compressive force on the continuous webs. The electrodes are compressed with the separator webs in these continuous webs. In principle, the electrodes are connected and laminated to the separator webs using a pressing device by exerting the compressive force. Additionally, lamination can be supported by the generation of heat caused by compressive force. Furthermore, additional heating or cooling zones can be provided that control the temperature of the continuous webs during lamination. In order to achieve a high-quality bond, it is desirable that the continuous webs are subjected to as equal a compressive force as possible over their longitudinal and transverse extension.

One problem here is that the electrode(s) are narrower than the continuous web(s) of the separator material, so that the separator material projects laterally beyond the electrode(s). This means that the electrodes have free edges on their edge sides, while the separator material overlaps the electrodes laterally.

If the electrodes in the continuous webs are already arranged at intervals from each other in the form of cut segments, the electrodes additionally form intermediate spaces in the continuous webs due to their spacing, with the electrodes additionally holding the separator webs at a distance from each other in the intermediate spaces due to their thickness. This means that the electrodes have additional free edges on the edge sides bordering the intermediate spaces.

Since the pressing force can only be increased to a limited extent so that the functionality of the electrodes is not impaired by excessive compression, and damage to the energy cells in the region of the edges is always detrimental to the quality of the energy cells and is therefore to be avoided as far as possible, the lamination of the continuous webs in the edge portions and, if present, in the regions of the intermediate spaces between the electrodes is problematic due to the free edges of the electrodes present there.

Against this background, the invention is based on the object of creating a laminating apparatus which enables improved lamination of the continuous webs in the edge zones adjacent to the electrodes with a reduced probability of damage to the electrodes in the region of the edges.

According to the invention, a laminating apparatus having the features of claim 1 is proposed to achieve the object. Further preferred embodiments of the invention can be found in the dependent claims, the figures, and the associated description.

According to the basic idea of the invention, it is proposed that the pressing device has a pressing surface with at least one outwardly projecting elevation, which is arranged such that when the compressive force is exerted, it comes into contact with a portion of the continuous web which adjoins an edge side of the electrode.

The elevation provided on the pressing surface in the proposed arrangement creates a contour of the pressing surface which relieves the adjacent edge of the electrode during lamination by adapting the pressing surface to the contour of the electrode in the region of the edge side of the electrode. The free edge of the electrode is thus practically received in the pressing surface or, in other words, enclosed by it. In extreme cases, the height of the first elevation can be such that it is supported on the separator web when a predetermined compressive force is exceeded during laminating of the continuous web, thus limiting a further increase in the load exerted on the electrode in the region of the edge. The elevation has the advantage that it makes it possible for a pressing force sufficient for the lamination to be exerted in the regions of the intermediate spaces between the electrodes or on the lateral edge sides of the electrodes without having to increase the overall pressing force. The pressing device compresses the separator webs of the continuous web in a stamp-like manner through the elevation in the region of the intermediate spaces and/or in the region of the edge sides of the electrodes by penetrating into the intermediate spaces between the electrodes and/or into the edge sides of the continuous web adjacent to the electrodes. The pressing force exerted on the electrodes can thus remain unchanged or even be reduced. This is particularly advantageous because the electrodes and the separator webs should be securely connected to each other during lamination, but should be subjected to as little compressive force as possible so that the material is not unnecessarily compacted and the ion exchange between the electrodes through the separator layer, which is important for the function and efficiency of the energy cell, is not reduced or even interrupted. A further advantage of the proposed solution is that the electrodes are additionally fixed in their alignment to the separator web during lamination by the elevations forming a lateral contact surface for the electrodes during lamination. The proposed solution is particularly advantageous when the electrode is narrower than the separator web and the separator web projects laterally beyond the electrode.

It is further proposed that the pressing device laminates the multilayer continuous web in the laminating apparatus by applying heat. The lamination, i.e., the bonding of the continuous webs of separator material among themselves and with the electrodes, is achieved by polymers penetrating from one layer into the other, which in turn is caused by the adhesion forces acting at the interfaces. It is precisely these adhesion forces that can be achieved more easily by applying heat. However, care must be taken to ensure that the material in the interfaces is not compacted to such an extent by the introduction of heat and the acting compressive force that the ion exchange, which is important for the function of the energy cell, is prevented.

It is further proposed that at least one first and one second elevation are provided on the pressing surface, which extend in the longitudinal direction of the continuous web and are arranged at a distance from each other which is greater than the distance between the edge sides of the electrode extending in the longitudinal direction of the continuous web. The first and second elevations improve the fixation of the electrode during lamination by fixing them to both edge sides of the continuous web running in the longitudinal direction parallel to the feed direction during lamination. The fixation of the electrodes does not have to take place at the same time. However, the fixation of the electrodes at their edge sides can be done at the same time, so that the electrodes are secured against slipping during lamination simultaneously and on both sides by the first elevation and the second elevation. The distance between the first elevation and the second elevation is the distance between the facing edge sides of the elevations, i.e., the width of the free recess between the two elevations.

It is further proposed that a plurality of electrodes arranged regularly at intervals from each other are provided in the continuous web, and that at least one third elevation and one fourth elevation are provided on the pressing surface, and the fourth elevation has a distance from the third elevation corresponding to the length of the electrodes in the longitudinal direction of the continuous web. The third and fourth elevations perform the same function as the first and second elevations and are arranged so that they penetrate into the intermediate spaces between the successive electrodes. The distance between the third elevation and the fourth elevation is specifically selected according to the length of the electrodes, so that the third elevation penetrates into one intermediate space and the fourth elevation into the subsequent intermediate space with a corresponding synchronization of the movements of the pressing surface to the continuous web. The distance between the third and fourth elevation is the distance between the facing edge sides of the two elevations. If the continuous web comprises a continuous web with an intermittent coating, the coated portions correspond to the electrodes and the distances between the coatings correspond to the distances between the electrodes.

The first elevation, the second elevation, the third elevation and the fourth elevation can preferably be shaped and arranged such that they complement each other to form a recess which corresponds to the outer shape of the electrodes. This means that the electrode is fixed on all sides at its edge sides during lamination, so that during lamination it is fixed both in the feed direction or longitudinal direction of the continuous web and perpendicular to it relative to the separator web.

It is further proposed that the pressing device comprises two press rollers with a circular cross section, which are arranged such that between their outer surfaces a gap is provided through which the continuous web runs. The advantage of the proposed solution is that by using press rollers in the proposed arrangement, the lamination can be preferably carried out in a drum run with a very high production capacity, i.e., transport speed of the continuous web.

It is further proposed that the gap has a gap width which is smaller than the thickness of the continuous web. The proposed gap dimensioning allows the compressive force required for lamination to be applied by the press rollers by transporting the continuous web through the gap. A special feed movement of the press rollers is therefore no longer necessary.

The first and/or the second elevation and/or the third elevation and/or the fourth elevation can preferably be arranged on a portion of the outer surface(s) of one or both press rollers. By forming the elevation(s) on the outer surface(s) of the press roller(s), this directly forms the pressing part adapted to the contour of the electrodes arranged in the continuous web.

It is further proposed that the first elevation and the second elevation are arranged on the edge sides of the outer surface. As a result, they come into contact with the edge portions of the continuous web as the press rollers roll along. The first elevation and the second elevation can be realized in the form of circumferential closed rings on the outer surface, so that they lie continuously on the continuous web with the first and second elevations and, in addition to the improved lamination, also form a guide for the continuous web.

It is further proposed that the third elevation and the fourth elevation are arranged parallel to at least one of the axes of rotation of the press roller and each elevate a portion of the outer surface, which, in the arc winding-up length of the outer surface, have a distance from each other which is greater than the length of the electrodes in the longitudinal direction of the continuous web.

Thanks to the proposed solution, with appropriate synchronization of the rotational movements of the press rollers and the transport movement of the continuous web, the press roller always penetrates with its third and fourth elevations precisely into the intermediate spaces between the successive electrodes without being able to damage the edge zones of the electrodes by rolling on the edges. The distance between the third and fourth elevations is the wound-up length of the outer surface between the facing edge sides of the elevations.

The press rollers are preferably arranged such that their axes of rotation are aligned parallel to each other. Due to the proposed arrangement of the press rollers, the rotary movements of the press rollers can be coupled and synchronized with each other using a very simply constructed gear mechanism without redirecting the rotational movements.

It is further proposed that the pressing device has at least one pressing belt which is arranged such that it comes into contact with one of the surfaces of the continuous web. The pressing belt can be used to equalize the pressing force acting on the continuous web. The pressing belt can preferably have an identical or larger width transverse to the feed direction of the continuous web so that the continuous web is subjected to the pressing force over its entire width and is thus laminated. The pressing belt can be designed in such a way that it generates the compressive force itself or is subjected to a compressive force via a separate pressure-generating device such as a press roller. In the latter case, the compressive force is generated by the press roller and transferred from the pressing belt to the continuous web. The pressing belt itself can be designed in the form of a flexible fiber-reinforced textile belt, a steel belt or a very fine link chain or the like. The pressing belt can be designed as a driven continuous belt or as a stationary pressing belt with a friction-reduced surface. If the pressing belt is designed as a driven continuous belt, it can also be used to transport the continuous web. However, if the pressing belt is formed by a stationary pressing belt, an additional device is required to transport the continuous web. In this case, the continuous web is actively pulled past the pressing belt.

In this case, the first elevation and/or the second elevation and/or the third elevation and/or the fourth elevation can also be arranged on the surface of the pressing belt, which is advantageous because the pressing belt rests on the surface of the continuous web and thus directly exerts or transmits the pressing force. This means that the contour of the pressing belt itself is adapted to the shape and geometry of the continuous web and the electrode(s) arranged on it by the arrangement of the elevation on it.

It is further proposed that two pressing belts are provided which are arranged such that between their opposite surfaces facing the continuous web a gap is provided through which the continuous web runs. The continuous web can thus be subjected to a compressive force and pressed from both sides via a pressing belt.

The gap width is preferably slightly smaller than the thickness of the continuous web, so that the continuous web is automatically subjected to a pressing force for lamination when it passes through and is supported accordingly by the pressing belts.

It is further proposed that the pressing device has two oppositely arranged pressing surfaces with which it comes into contact with different sides of the continuous web, and that first elevations and/or second elevations and/or third elevations and/or fourth elevations are provided on the pressing surfaces, and that the first elevations, second elevations, third elevations and/or fourth elevations of the pressing surfaces have different distances from each other and/or different heights and/or different shapes.

Due to the different distances between the elevations, the pressing surfaces in the mold can be individually designed in relation to the contour of the two sides of the continuous web. If the continuous web is formed, for example, as a four-ply continuous web or a five-ply continuous web with cathodes and anodes arranged therein according to the structure described above, this can take into account the fact that the anodes are generally larger than the cathodes and thus the edges to be protected of the anodes have larger distances than the edges of the cathodes. Furthermore, the elevations can have different heights, so that the compressive forces exerted can be adapted differently in their distribution and size to the surfaces of the continuous webs. If two opposing pressing surfaces with corresponding elevations are provided, the pressing plane can be specifically designed in relation to the continuous web, and in particular can be designed asymmetrically to the center plane of the continuous web, by dimensioning the heights of the opposing elevations differently. Furthermore, the different shapes of the recesses allow different courses of the edges of the electrodes to be taken into account.

It is also proposed that the pressing surface be adjustable in its width. Due to the adjustability of the width of the pressing surface, the laminating apparatus can be set to laminate continuous webs of different widths. The width of the pressing surface is the perpendicular direction to the longitudinal direction of the continuous web in the plane of the continuous web.

Furthermore, the pressing surface can preferably have a width which corresponds to the width of the continuous web or a multiple thereof. The proposed solution means that the laminating apparatus is specifically designed to laminate a continuous web of a specific width, or a plurality of continuous webs of a specific width can also be laminated in a parallel arrangement. If the pressing surface is adjustable, predetermined positions of the widths of the pressing surface can also be provided for this purpose, so that the pressing surface can be adjusted with little effort from a position for laminating a single continuous web to a position for two or more continuous webs arranged in parallel.

It is further proposed that at least one elevation be heatable. By heating the elevation(s), the lamination can be supported locally in addition to the exerted compressive force, wherein the shape of the heatable elevation(s) and the temperature can be specifically adapted to the shape of the surface to be laminated.

The invention is explained below using preferred embodiments with reference to the accompanying figures, in which:

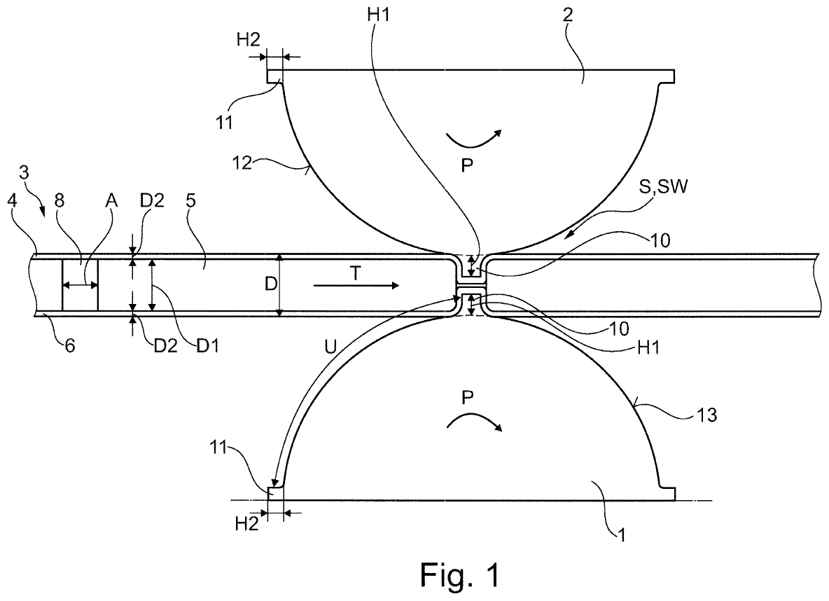

FIG. 1 shows a detail of a laminating apparatus according to the invention with a continuous web and a pressing device with two press rollers; and

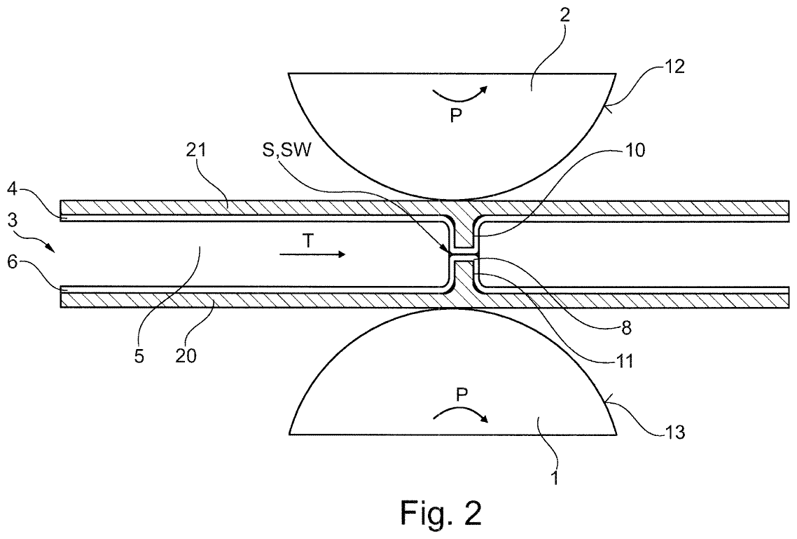

FIG. 2 shows a detail of a laminating apparatus according to the invention with a continuous web and a pressing device with two press rollers and two pressing belts.

FIG. 1 shows a detail of a laminating apparatus according to the invention. The laminating apparatus comprises a pressing device with two press rollers 1 and 2, which are designed as cylindrical drums with a circular cross section. The press rollers 1 and 2 are aligned with their axes of rotation parallel to each other and arranged such that between their outer surfaces 12 and 13 there is a gap S with a constant gap width SW in the direction of the axes of rotation of the press rollers 1 and 2, i.e., perpendicular to the plane of representation.

Furthermore, a continuous web 3 to be laminated is provided, which runs through the gap S and has a thickness D. The continuous web 3 is formed by a “three-ply” continuous web 3 with a separator web 4 on the upper side and a separator web 6 on the lower side and electrodes 5 arranged in between. The electrodes 5 are arranged with intermediate spaces 8 at identical distances A from each other and have a smaller width than the separator webs 4 and 6, so that the separator webs 4 and 6 project laterally beyond the electrodes 5. Since the anodes are generally larger than the cathodes in the energy cell, but the separator webs 4 and 6 are identical and serve for the arrangement of both the anodes and the cathodes, the distances A between the intermediate spaces 8 and the free lateral edge zones are particularly large when the electrodes 5 are the cathodes. Conversely, the distances A between the intermediate spaces 8 and the free edge sides are smaller when the electrodes 5 and the anodes are involved.

The gap width SW of the gap S is smaller than the thickness D of the continuous web 3, so that the continuous web 3 is slightly compressed and laminated as it passes through the gap S. The thickness D2 of the separator webs 4 and 6 is 15 to 25 μm, while the electrodes 5 have a thickness D1 of 150 to 400 μm. This results in a thickness D of the electrode web 3 of approximately 180 μm to 450 μm in the present embodiment. The gap width SW is smaller by 20 to 100 μm, preferably 40 to 60 μm, than the thickness D of the continuous web 3, so that the continuous web 3 is slightly compressed when passing through the gap S. The intermediate spaces 8 are formed by the spacing of the electrodes 5 and have a height which corresponds to the thickness D1 of the electrodes 5, i.e., 150 to 400 μm. Furthermore, the intermediate spaces 8 have a length in the feed direction T of the continuous web 3 corresponding to the distance A of the electrodes 5 of 3 mm between the anodes and 6 mm between the cathodes, wherein it is desirable to make the distances A between the electrodes 5 as small as possible in order to increase the material utilization rate of the continuous web 3 and the number of electrodes 5 in a predetermined length of the continuous web 3.

The continuous web 3 is transported in the feed direction T and is pulled through the gap S during the transport. The press rollers 1 and 2 can themselves be actively driven, for example by individual drives in the form of servo motors, to rotational movements directed opposite the direction of the arrows P, so that they additionally actively transport the continuous web 3 by means of the frictional connection. Alternatively, the press rollers 1 and 2 can also be only rotatably mounted, so that they themselves are driven by the continuous web 3 through the frictional connection to the rotational movements. In this case, the press rollers 1 and 2 roll only passively on the surfaces of the continuous web 3.

Third elevations 10 and fourth elevations 11 are provided on the two press rollers 1 and 2 in the form of cams or surface portions projecting radially outward from the outer surfaces 12 and 13, which in the circumferential winding-up portion relative to the axes of rotation of the press rollers 1 and 2 are narrower than the distances A of the electrodes 5 in the intermediate spaces. Insofar as the invention is described with reference to the third and fourth elevations 10 and 11 and subsequently with reference to the first and second elevations, the designation first, second, third and fourth does not imply any order or hierarchy. Thus, the terms “third” and “fourth” do not necessarily presuppose the existence of a first and second elevation, and vice versa. The designations serve only to distinguish the elevations, wherein the elevations are each defined by their orientation and arrangement in relation to each other.

The third and fourth elevations 10 and 11 have a height H1 and H2 starting from the outer surfaces 12 and 13, the sum of which corresponds to a maximum of the thickness D1 of the electrodes 5, i.e., depending on the thickness D of the electrodes 5, between 150 μm and 400 μm. The third and fourth elevations 10 and 11 are arranged on the press rollers 1 and 2 in such a way that during the transport movement of the continuous web 3 and the rotational movements of the press rollers 1 and 2 they come into contact with the continuous web 3 in the region of the intermediate spaces 8 and compress the separator webs 4 and 6 in the region of the intermediate spaces 8. The heights H1 and H2 of the third and fourth elevations 10 and 11 can be designed specifically for the continuous web 3 to be laminated and taking into account the distances A of the intermediate spaces, the thicknesses D2 of the separator webs 4 and 6 and the thicknesses D1 of the electrodes 5. The third and fourth elevations 10 and 11 can deliberately have different heights H1 and H2, preferably between 0 and 400 μm, so that they penetrate into the intermediate spaces to different depths and an asymmetrical separation plane is created between the third and fourth elevations 10 and 11 with respect to the center plane of the electrode 5.

Furthermore, the third and fourth elevations 10 and 11 additionally form a positive bond between the press rollers 1 and 2 and the continuous web 3, so that the press rollers 1 and 2 are connected to the continuous web 3 in an improved manner with regard to the power transmission for an active drive of the continuous web 3. The same applies, of course, if the press rollers 1 and 2 are not actively driven and are driven by the continuous web 3.

It is important for the solution according to the invention that the width of the third and fourth elevations 10 and 11 formed by the arc winding-up length of the radially outer end faces of the third elevations 10 and fourth elevations 11 in the circumferential direction of the press rollers 1 and 2, taking into account the thicknesses D2 of the separator webs and the distances A of the electrodes, is dimensioned such that the separator webs 4 and 6 are pressed against each other in the region of the intermediate spaces 8, in that the third and fourth elevations 10 and 11 are supported on the separator webs 4 and 6.

Furthermore, in addition to the third elevations 10 on the press rollers 1 and 2, fourth elevations 11 or further elevations of identical or different shape can be provided, which are arranged on the outer surfaces 12 and 13 such that the distance U to the third elevations 10, formed by the winding-up length of the arc segments in the direction of rotation of the press rollers 1 and 2, corresponds in each case to the length of the electrodes 5 plus a tolerance value in the direction of the longitudinal direction of the continuous web 3. Thus, the press rollers 1 and 2 with the third elevations 10 always penetrate into one of the intermediate spaces 8 and the fourth elevations 11 always penetrate into the subsequent intermediate spaces 8 of the continuous web 3 between the electrodes 5 and laminate the continuous web 3.

The outer surfaces 12 and 13 here form the pressing surfaces of the pressing device, which are individually contoured for the continuous web 3 to be laminated by the formation of the third elevations 10 and fourth elevations 11 and, if present, by the further elevations. The third elevations 10 and the fourth elevations 11 and the intermediate spaces 8 are exaggerated for the sake of clarity.

FIG. 2 shows an alternative embodiment of the invention. In addition to the two press rollers 1 and 2, the pressing device here also comprises two pressing belts 20 and 21, which rest on the upper side and the lower side of the continuous web 3. The press rollers 1 and 2 are designed and arranged identically to the press rollers 1 and 2 of FIG. 1 and differ only in that they are designed as cylindrical drums with an outer surface 12 and 13 with an identical radius over the circumference. The press rollers 1 and 2 rest on the free surfaces of the two pressing belts 20 and 21. The pressing belts 20 and 21 are provided with the third elevations 10 and fourth elevations 11 on their surfaces facing the continuous web 3 and thus form the pressing surface of the pressing device acting on the continuous web 3. However, the press rollers 1 and 2 can also have different diameters and radii, provided that this is advantageous for lamination.

The third elevations 10 and fourth elevations 11 of the pressing belts 20 and 21 are dimensioned and arranged corresponding to the third elevations 10 and fourth elevations 11 on the press rollers 1 and 2 of the first embodiment. The relevant gap S and the gap width SW for laminating the continuous web 3 is in this case defined by the distance between the pressing belts 20 and 21, so that the press rollers 1 and 2 with their outer surfaces 12 and 13 have a distance increased by the sum of the thicknesses of the pressing belts 20 and 21. Furthermore, further elevations can be arranged on the pressing belts 20 and 21, which have a distance from each other that is greater than the length of the electrodes 5 in the feed direction T of the continuous web 3. The distance between the elevations is the distance between the facing edge sides of the elevations.

Alternatively or additionally, in addition to the third and fourth elevations 10 and 11 on the edge sides of the pressing belts 20 and 21 or the press rollers 1 and 2 in the embodiment of FIG. 1, further first and second elevations can be provided which compress the separator webs 4 and 6 in the edge portions and adjoin the edge sides of the electrodes 5 running in the feed direction T.

If both third and fourth elevations 10 and 11 and first and second elevations are provided, the third and fourth elevations 10 and 11 can complement the first and second elevations and/or the further elevations to such an extent that they form recesses which correspond to the outer shape of the electrodes 5, so that the press rollers 1 and 2 or the pressing belts 20 and 21 laminate the continuous web 3 in a stamp-like manner without exerting an increased compressive force on the electrodes 5.

The pressing surfaces form, through the third and fourth elevations 10 and 11 and the first and second or, if present, through the further elevations, all together a contour surface the shape of which is individually adapted to the continuous web 3 to be laminated, by means of which the continuous web 3 can be laminated in an improved manner, also taking into account the intermediate spaces 8 and the edge portions of the separator webs 4 and 6 projecting beyond the electrodes 5.

The press rollers 1 and 2 here form a pressure-generating device which exerts a compressive force on the pressing belts 20 and 21. However, a rod carpet, a stamping unit with corresponding pressure cylinders, pneumatic pressure-generating devices with, for example, inflatable cushions or the like can also be used as the pressure-generating device, provided that they are suitable for applying the necessary pressure evenly to the pressing belts 20 and 21.

In the embodiments, the lamination of a continuous web 3 with cut electrodes 5 arranged at distances A from each other has been described. However, it is also conceivable to laminate a continuous web 3 with a continuous electrode web using the laminating apparatus. In this case, the third and fourth elevations 10 and 11 are omitted and only the first and second elevations are provided in the region of the edge sides of the pressing surfaces. The first and second elevations are designed, corresponding to the overlapping edges of the separator webs 4 and 6, as continuous raised edges in the case of the realization of the pressing surfaces on the pressing belts 20 and 21, or as projecting rings on the edge sides of the outer surfaces 12 and 13 in the case of the realization of the pressing surfaces on the press rollers 1 and 2.

The first elevations and second elevations run in the longitudinal direction of the pressing surfaces, the continuous web 3 to be laminated, and the feed direction T, and can thus also be regarded as longitudinal ribs which are arranged parallel to each other and have at least a distance from each other corresponding to the width of the electrodes 3. The third elevations 10 and fourth elevations 11 run transversely to the pressing surfaces, the laminating continuous web 3, and the feed direction T, and can thus also be regarded as transverse ribs, which each have a distance from each other that is greater than the length of the electrodes 5 in the longitudinal direction of the continuous web 3.

If the electrodes 5 are arranged uncut in the continuous web 3, i.e., are arranged in a single piece, the intermediate spaces 8 and thus also the third and fourth elevations 10 and 11 are omitted, and only the first and second elevations are provided. Furthermore, the first and second elevations in the edge sides of the pressing surfaces can be individually or both omitted, provided that a corresponding relief of the edges is not required here, so that in this case only the third and/or the fourth elevations 10 and 11 can be provided.

In general, the load on the continuous web 3 during lamination in the region of the edges of the electrodes 5 is reduced by the fact that the pressing surfaces enclose the electrodes 5 in the region of the edges. If the pressure on the continuous web 3 increases in its thickness, e.g., due to shape inaccuracies of the continuous web 3, the pressing movement of the continuous web 3 is limited by the pressing device being supported on a separator web 4 or 6 via the first, second, third and/or fourth elevations 10 and 11. Thus, the compressive force exerted by the pressing device on the continuous web 3 and in particular on the electrodes 5 in the region of the edges is limited to a maximum value. Furthermore, the elevations simultaneously form a positive-fitting contact surface, fixing the electrodes 5 in one direction during lamination. This is particularly advantageous if the electrodes 5 are already cut in the continuous web 3 and the third and fourth elevations 10 and 11 penetrate into the intermediate spaces 8, thereby fixing the electrodes 5 in their alignment with each other to create an intermediate space 8 with a minimum distance.

Furthermore, the heights H1 and H2 of the third and fourth elevations 10 and 11 can be specifically selected such that the continuous web 3 is laminated in a defined pressing plane in the edge portions adjacent to the electrodes 5. The same also applies, of course, to the heights of the first and second elevations, which are not shown in the figures.

The designation of the elevations as first, second, third, and fourth elevation serves only to distinguish the elevations. It is not necessary for the realization of the concept of the invention that, when the third and fourth elevations 10 and 11 are realized, the first and second elevations must necessarily also be realized. In this case, the first elevation according to claim 1 would be realized by the third or fourth elevation 10 or 11. The same applies to the opposite case where no third and fourth elevations 10 and 11 are provided, but instead only the first and second elevations are provided, on the edge sides of the pressing surfaces.

Both the first and second elevations as well as the third and fourth elevations 10 and 11 can be heatable individually or in combination, so that their temperature can be individually set for improved lamination. However, it is also conceivable to design the elevations as purely passive, i.e., not heatable, and to bring about the lamination only via the pressure exerted.

1. A laminating apparatus for a multilayer continuous web made up of at least one separator web and at least one electrode for producing energy cells, having
a pressing device that laminates the multilayer continuous web by exerting a compressive force,
wherein
the pressing device has two oppositely arranged pressing surfaces with at least one outwardly projecting elevation, which are arranged such that when the compressive force is exerted, each comes into contact with a portion with different sides of the continuous web which adjoins an edge side of the electrode and the elevations of the oppositely arranged pressing surfaces having different heights.

2. The laminating apparatus according to claim 1, wherein
the pressing device laminates the multilayer continuous web by applying heat.

3. The laminating apparatus according to claim 1, wherein
at least one first and one second elevation are provided on the pressing surface, which extend in the longitudinal direction of the continuous web and are arranged at a distance from each other which is greater than the distance between the edge sides of the electrode extending in the longitudinal direction of the continuous web.

4. The laminating apparatus according to claim 1, wherein
a plurality of electrodes arranged regularly at distances from each other are provided in the continuous web, and
at least one third elevation and one fourth elevation are provided on the pressing surface, and
the fourth elevation has a greater distance from the third elevation than the length of the electrodes in the longitudinal direction of the continuous web.

5. The laminating apparatus according to claim 4, wherein
the first elevation, the second elevation, the third elevation and the fourth elevation- are shaped and arranged such that they complement each other to form an elevation the shape of which corresponds to the outer shape of the electrodes.

6. The laminating apparatus according to claim 4, wherein
the pressing device comprises two press rollers with a circular cross section, which are arranged such that between their outer surfaces a gap is provided through which the continuous web runs.

7. The laminating apparatus according to claim 6, wherein
the gap has a gap width which is smaller than the thickness of the continuous web.

8. The laminating apparatus according to claim 4, wherein
the first elevation and/or the second elevation and/or the third elevation and/or the fourth elevation are arranged on a portion of the outer surface of one of the, or both, press rollers.

9. The laminating apparatus according to claim 8, wherein
the first elevation and the second elevation are arranged on the edge sides of the outer surface.

10. The laminating apparatus according to claim 8, wherein
the third elevation and the fourth elevation are arranged parallel to at least one of the axes of rotation of the press rollers, and
the third elevation and the fourth elevation in the of the arc winding-up length of the outer surface have a distance from each other which is greater than the length of the electrodes in the longitudinal direction of the continuous web.

11. The laminating apparatus according to claim 6, wherein
the press rollers are arranged such that their axes of rotation are aligned parallel to each other.

12. The laminating apparatus according to claim 1, wherein
the pressing device has at least one pressing belt which is arranged such that it comes into contact with one of the surfaces of the continuous web.

13. The laminating apparatus according to claim 12, wherein
the elevation(s) is or are arranged on the surface of the pressing belt.

14. The laminating apparatus according to claim 12, wherein
two pressing belts are provided, which are arranged such that between their opposite surfaces facing the continuous web a gap is provided through which the continuous web runs.

15. The laminating apparatus according to claim 14, wherein
the gap width of the gap is slightly smaller than the thickness of the continuous web.

16. The laminating apparatus according to claim 1, wherein
first elevations and/or second elevations and/or third elevations and/or fourth elevations are provided on the pressing surfaces, and
the first elevations, second elevations, third elevations and/or fourth elevations of the pressing surfaces have different distances from each other and/or different heights and/or different shapes.

17. The laminating apparatus according to claim 1, wherein
the pressing surface is adjustable in width.

18. The laminating apparatus according to claim 1, wherein
the pressing surface has a width which corresponds to the width of the continuous web or a multiple thereof.

19. The laminating apparatus according to claim 1, wherein
at least one elevation is heatable.

20. The laminating apparatus according to claim 6, wherein
the first elevation and/or the second elevation and/or the third elevation and/or the fourth elevation are arranged on a portion of the outer surface of one of the, or both, press rollers.
